(19) United States
(12) Patent Application Publication
(10) Pub. No.: US 2026/0368792 A1
(43) Pub. Date: Nov. 19, 2026

(54) PRODUCT SPECIFYING DEVICE, PRODUCT SPECIFYING METHOD, AND RECORDING MEDIUM

(71) Applicant: NEC Corporation, Tokyo (JP)

(72) Inventor: Manabu NAKANOYA, Tokyo (JP)

(73) Assignee: NEC Corporation, Tokyo (JP)

(21) Appl. No.: 19/662,060

(22) Filed: Apr. 29, 2026

(30) Foreign Application Priority Data
May 19, 2025 (JP) 2025-083058

(51) Int. Cl. G06Q 30/0601; G06V 10/764

(52) U.S. Cl. CPC G06Q 30/0623; G06V 10/764

(57) ABSTRACT

A product specifying device includes an acquisition unit for acquiring an image in which a product is captured, a category specifying unit for specifying a product category of the product by using a VLM, and a product specifying unit for specifying the product by using a product specifying model corresponding to the specified product category, in which the category specifying unit inputs, to a VLM, an instruction to specify the product category based on the image and a category list that is a list of product categories supported by a product specifying model.

This application is based upon and claims the benefit of priority from Japanese Patent Application No. 2025-083058, filed on May 19, 2025, the disclosure of which is incorporated herein in its entirety by reference.

### TECHNICAL FIELD

The present disclosure relates to a product specifying device, a product specifying method, and a recording medium.

### BACKGROUND ART

There is a technology for specifying, based on an image, a product captured in the image. In a case where a large number of candidates for the product captured in the image exist, it may be difficult to uniquely specify the product.

JP 2018-512655 A describes a system that predicts a product category of a product and detects the product by using a product detection module corresponding to the predicted product category.

### SUMMARY

One object of the present disclosure is to provide a product specifying device and the like capable of improving a product specifying accuracy based on an image.

A product specifying device according to an aspect of the present disclosure includes acquisition means for acquiring an image in which a product is captured; category specifying means for specifying a product category of the product by using a Vision Language Model (VLM); and product specifying means for specifying the product by using a product specifying model corresponding to the specified product category, in which the category specifying means inputs, to a VLM, an instruction to specify the product category based on the image and a category list that is a list of product categories supported by the product specifying model.

A product specifying method according to another aspect of the present disclosure includes acquiring an image in which a product is captured; by inputting an instruction to specify a product category of the product captured in the image to a VLM, specifying the product category of the product captured in the image based on the image and a category list that is a list of product categories supported by a product specifying model; and specifying the product by using a product specifying model corresponding to the specified product category.

A program according to another aspect of the present disclosure causes a computer to execute processing of acquiring an image in which a product is captured; by inputting an instruction to specify a product category of the product captured in the image to a VLM, specifying the product category of the product captured in the image based on the image and a category list that is a list of product categories supported by a product specifying model; and specifying the product by using a product specifying model corresponding to the specified product category.

Each program may be stored in a computer-readable non-transitory recording medium.

### BRIEF DESCRIPTION OF THE DRAWINGS

Exemplary features and advantages of the present disclosure will become apparent from the following detailed description if taken with the accompanying drawings in which:

FIG. 1 is a block diagram illustrating an example of a configuration of a system including a product specifying device;

FIG. 2 is a diagram illustrating an example of a category list;

FIG. 3 is a diagram illustrating another example of a category list;

FIG. 4 is a first flowchart illustrating an example of an operation of a product specifying device;

FIG. 5 is a block diagram illustrating an example of a configuration of a product specifying device;

FIG. 6 is a second flowchart illustrating an example of an operation of a product specifying device; and

FIG. 7 is a diagram illustrating an example of a hardware configuration of a product specifying device.

### EXAMPLE EMBODIMENT

An example embodiment of the present disclosure will be described in detail with reference to the drawings.

### First Example Embodiment

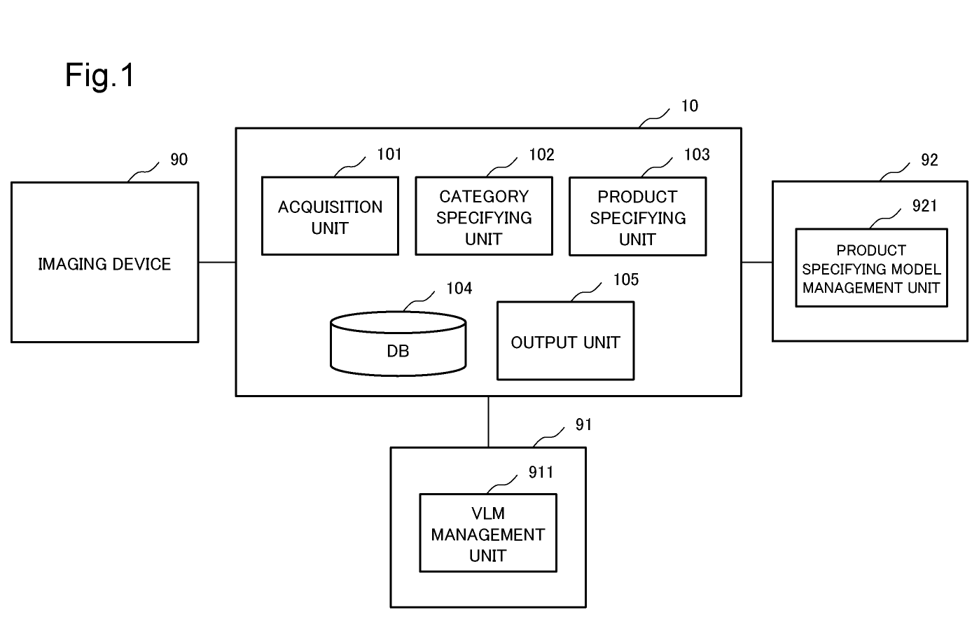

With reference to FIG. 1, a configuration example of a system including a product specifying device 10 will be described. FIG. 1 is a block diagram illustrating an example of a configuration of a system including a product specifying device. The system includes the product specifying device 10, an imaging device 90, a VLM server device 91, and a product specifying model server device 92. The product specifying device 10 is connected to each of the imaging device 90, the VLM server device 91, and the product specifying model server device 92 via a wired or wireless network.

The imaging device 90 is a device that captures an image of a product handled in a store. In a store, a product may be displayed on a product shelf. The imaging device 90 captures, for example, an image of a product displayed on the product shelf. The image captured by the imaging device 90 may include, in addition to the product, an object different from the product. For example, the image may include, in addition to the product, the product shelf on which the product is displayed.

The imaging device 90 is, for example, a camera installed in a store. The imaging device 90 may be a device portable by a clerk of the store. Examples of the imaging device 90 are not limited to these. In addition, with reference to FIG. 1, the number of imaging devices 90 is one, but the number of imaging devices 90 is not limited thereto. A plurality of imaging devices 90 may be connected to the product specifying device 10. The plurality of imaging devices 90 may be capable of imaging different areas in the store, for example.

The VLM server device 91 includes a VLM management unit 911. The VLM management unit 911 manages a VLM. That is, the VLM server device 91 is a server device including the VLM. The VLM is capable of generating, based on an input image, a sentence representing an object captured in the image. For example, in a case where an image in which a product is captured is input to the VLM, a sentence representing the product can be generated by the VLM. As the sentence representing the product, a sentence representing a product category of the product may be generated. The sentence representing the product may be a word.

The product specifying model server device 92 includes a product specifying model management unit 921. The product specifying model management unit 921 manages a product specifying model. That is, the product specifying model server device 92 is a server device including a product specifying model. The product specifying model is, for example, a model trained using images of products for the products handled in a store. The product specifying model is a model trained to output product information including product identification information by using an image in which a product is captured, as an input. The product specifying model is, for example, a model trained using a convolutional neural network. The product specifying model is not limited thereto. The product specifying model may be a model trained by a known technique. The product specifying model may be referred to as, for example, a product classification model or the like.

In a case where an image is input to the product specifying model, a product captured in the image is specified. As a specified result of the product specifying model, product information is output. The product information includes product identification information. The product identification information is information capable of uniquely specifying a product. The product identification information is, for example, a product number. The product identification information may also be a product name. The product identification information is not limited thereto. The product identification information may also be a combination of a sales company and a product name. That is, a product is uniquely specified by the product specifying model. Uniquely specifying a product is referred to as specifying a product. The product information may include information related to the product in addition to the product identification information.

The product specifying model is prepared for each product category. Here, the product category is a classification of products. Products handled in a store are classified in accordance with characteristics of the products. That is, the product category is, for example, a classification based on characteristics of the product. Examples of the product category include “tea”, “coffee”, “water”, “soft drink”, and “alcohol”.

In addition, the product category may include a major category and a minor category obtained by subdividing the major category. Examples of the major category include “beverage”, “processed food”, “bread and confectionery”, and “daily necessity”. An example of the minor categories included in the major category “beverage” includes “tea”, “coffee”, “water”, “soft drink”, and “alcohol”. In this case, the product specifying model may be prepared for each minor category.

The VLM management unit 911 and the product specifying model management unit 921 may be provided in the same server device. That is, a single server device may include a VLM and a product specifying model.

With reference again to FIG. 1, a configuration of the product specifying device 10 will be described. As illustrated in FIG. 1, the product specifying device 10 includes an acquisition unit 101, a category specifying unit 102, and a product specifying unit 103. In addition, the product specifying device 10 may include a database 104 and an output unit 105.

The acquisition unit 101 is an aspect of acquisition means for acquiring an image in which a product is captured. The acquisition unit 101 acquires, from the imaging device 90, an image captured by the imaging device 90. The imaging device 90 captures an image of a product. Therefore, the acquisition unit 101 is capable of acquiring an image in which a product in a store is captured.

The image acquired by the acquisition unit 101 may be stored in the database 104, for example. The database 104 is a database capable of storing images in which products are captured. The image captured by the imaging device 90 may also be stored in, for example, a database provided in an information processing device (not illustrated) different from the product specifying device 10. That is, the database 104 may be provided in an information processing device different from the product specifying device 10. The information processing device is connected to the imaging device 90 and the product specifying device 10 via a wired or wireless network. The acquisition unit 101 may acquire an image in which a product is captured, from the information processing device. In the following description, a case where the product specifying device 10 includes the database 104 will be described as an example.

The acquisition unit 101 may extract text information included in an image. The image captured by the imaging device 90 may include text. For example, a product captured in an image may have text written thereon. As a specific example, text such as a product name or a catchphrase may be printed on packaging of a product. In addition, a product shelf on which a product is displayed may have a price tag or an advertisement installed thereon. The price tag or the advertisement may include text. Accordingly, the acquisition unit 101 may extract text information. The text information is information of text included in an image. The text information is, for example, information of text written on a product. A known technique is used to extract the text information.

The acquisition unit 101 may acquire text information as, for example, an extraction result of text included in an image. That is, acquisition of the text information is one example of extraction of the text information. The text information is extracted from an image. A known technique is used to extract the text information. Extraction of text information may be performed in an information processing device different from the product specifying device 10. The information processing device acquires an image in which a product is captured. Text included in the image is extracted in the information processing device. The acquisition unit 101 is capable of acquiring text information as an extraction result of text included in the image, from the information processing device. The acquisition unit 101 may extract, for example, a character string as the text information. The method for extracting the text information is not limited to these. For example, the product specifying device 10 may include an extraction unit (not illustrated) that extracts text included in an image. In this case, the acquisition unit 101 is capable of acquiring text information as an extraction result of text included in the image, from the extraction unit.

The category specifying unit 102 is an aspect of category specifying means for specifying a product category of a product by using a VLM. The category specifying unit 102 inputs, to the VLM, an instruction to specify a product category based on an image and a category list as a list of product categories supported by the product specifying model. The category specifying unit 102 acquires a specified result of the category as an output from the VLM. The category specifying unit 102 is capable of specifying the product category by acquiring the specified result of the category.

As described above, the product category is a classification of products. A product specifying model is prepared for each product category. A product handled in a store belongs to one of product categories for which a product specifying model is prepared. The product category may include a major category and a minor category obtained by subdividing the major category. In this case, a product category for which a product specifying model is prepared corresponds to a minor category. The major category includes a plurality of minor categories.

A category list is a list of product categories. The category list is a list of categories for which a product specifying model is prepared. In a case where the product category includes a major category and a minor category, a list of major categories is a major-category list, and a list of minor categories is a minor-category list.

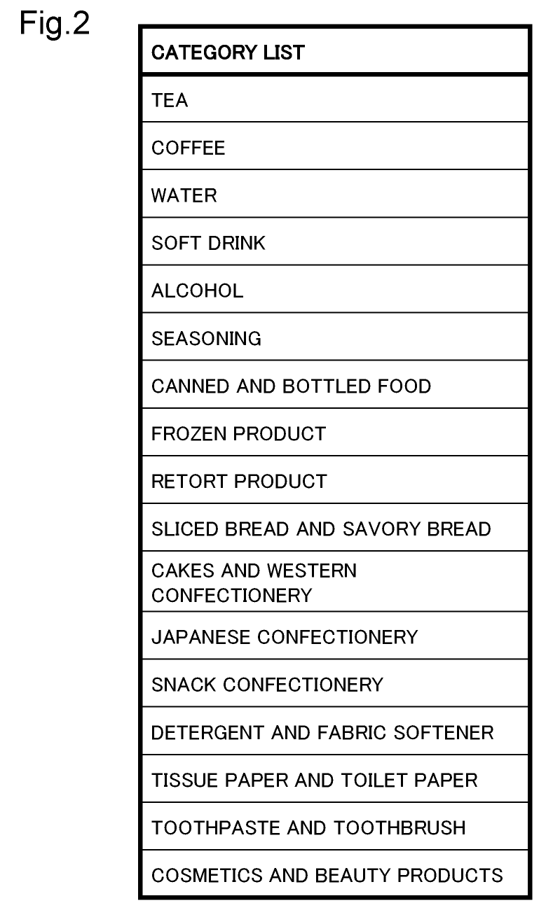

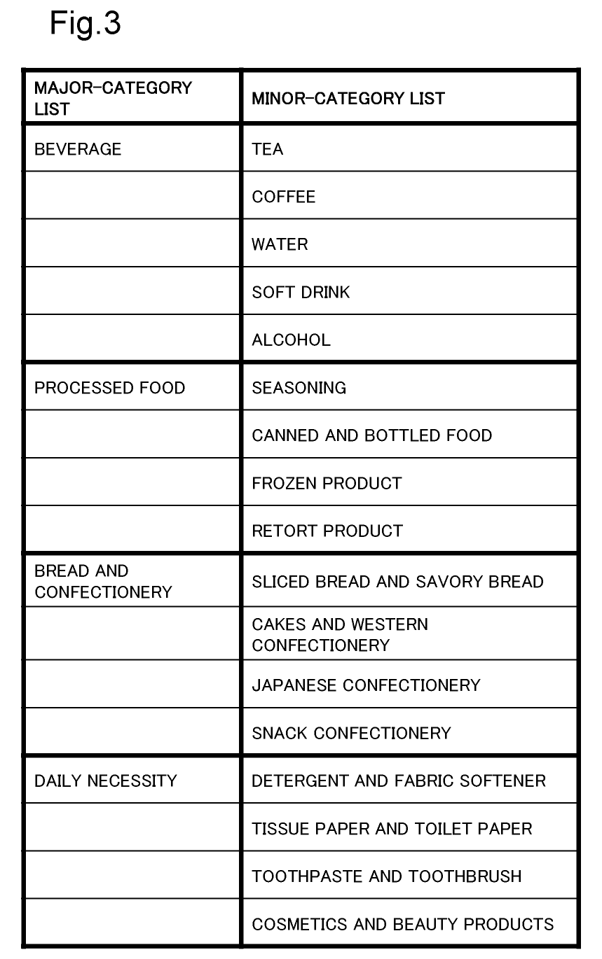

The category list will be described with reference to FIGS. 2 and 3. FIG. 2 is a diagram illustrating an example of a category list. FIG. 3 is a diagram illustrating another example of a category list. FIG. 2 illustrates an example of a category list including a plurality of product categories. The product categories are not limited to these. A product specifying model is prepared for each of the product categories included in FIG. 2.

FIG. 3 illustrates an example of a category list in a case where the product categories include a major category and a minor category. The major-category list includes, as major categories, “beverage”, “processed food”, “bread and confectionery”, and “daily necessity”. The major categories are not limited to these. In FIG. 3, each of the major categories includes a plurality of minor categories. For example, the major category “beverage” includes “tea”, “coffee”, “water”, “soft drink”, and “alcohol”. Examples of the major categories and the minor categories are not limited to these. A product specifying model is prepared for each of the minor categories in FIG. 3.

The category list is stored in, for example, the database 104. The database 104 is capable of storing the category list. The category list may be stored in a database provided in an information processing device different from the product specifying device 10.

The category specifying unit 102 inputs, to the VLM, the image acquired by the acquisition unit 101. In this case, the category specifying unit 102 inputs, to the VLM, an instruction to specify a product category of a product captured in the image. The category specifying unit 102 inputs a category list to the VLM. That is, the category specifying unit 102 transmits, to the VLM server device 91, the image acquired by the acquisition unit 101, the category list, and an instruction to specify a product. In a case where the category list is stored in the database 104, the category specifying unit 102 reads the category list from the database 104. Then, the category specifying unit 102 transmits the category list to the VLM server device 91. The category specifying unit 102 acquires a specified result of the category as an output from the VLM. That is, the category specifying unit 102 acquires the specified result of the category from the VLM server device 91. A product specifying model to be used for specifying a product to be described below is selected in accordance with the specified product category.

The category specifying unit 102 can input, to the VLM, for example, the image in which a product is captured, the category list illustrated in FIG. 2, and the instruction to specify a product category. In this case, the category list to be input may be in a text format or may be an image. The VLM is capable of specifying a product category of a product captured in the image, from among the product categories included in the category list. The category specifying unit 102 acquires a specified result of the product category obtained by the VLM. The specified result of the category may be in a text format or may be an image. It is sufficient that the specified result of the category includes a product category of the product captured in the image.

The category specifying unit 102 may acquire the specified result of the product category by inputting a plurality of instructions to the VLM. A case where the product category includes a major category and a minor category will be described. The category specifying unit 102 inputs, to the VLM, an instruction to specify a major category based on a major-category list of major categories and an image. The category specifying unit 102 further inputs, to the VLM, an instruction to specify a product category based on a minor-category list of minor categories corresponding to the major category specified by the VLM. The category specifying unit 102 is capable of acquiring a specified result of the product category obtained by the VLM.

The description will be made with reference to FIG. 3. The category specifying unit 102 inputs, to the VLM, a major-category list illustrated as an example in FIG. 3 and an image in which a product is captured. In this case, the category specifying unit 102 inputs, to the VLM, an instruction to specify a product category of a product captured in the image, from among major categories included in the major-category list. The category specifying unit 102 is capable of acquiring a specified result of the major category obtained by the VLM.

The category specifying unit 102 inputs, to the VLM, a minor-category list of minor categories included in the major category specified by the VLM. In this case, the category specifying unit 102 inputs, to the VLM, an instruction to specify a product category of the product captured in the image, from among minor categories included in the minor-category list. For example, in a case where the VLM specifies the major category as “beverage”, the minor-category list input by the category specifying unit 102 includes “tea”, “coffee”, “water”, “soft drink”, and “alcohol”. Then, the category specifying unit 102 is capable of inputting, to the VLM, an instruction to specify a product category from among “tea”, “coffee”, “water”, “soft drink”, and “alcohol” included in the minor-category list. The category specifying unit 102 is capable of acquiring a specified result of the minor category obtained by the VLM. The minor category corresponds to a category for which a product specifying model is prepared. Therefore, a product specifying model to be used for specifying a product to be described below is selected in accordance with the specified minor category.

Another method of acquiring a specified result of a product category by inputting a plurality of instructions to the VLM will be described. The category specifying unit 102 inputs, to the VLM, an instruction to specify a product category based on an image. Then, the category specifying unit 102 further inputs, to the VLM, an instruction to specify a product category based on a category list corresponding to the product category specified by the VLM. The category specifying unit 102 is capable of acquiring a specified result of the product category obtained by the VLM.

The description will be made with reference to the drawings. First, the category specifying unit 102 inputs, to the VLM, an image in which a product is captured and an instruction to specify a product based on the image. That is, the category specifying unit 102 does not input a category list to the VLM. The category specifying unit 102 acquires a specified result of the product category obtained by the VLM. In this case, the product category specified by the VLM may not correspond to a category for which a product specifying model is prepared.

A case where the product category specified by the VLM does not correspond to a category for which a product specifying model is prepared includes, for example, a case where a product category that is not included in categories for which a product specifying model is prepared is specified. A case where the product category specified by the VLM does not correspond to a category for which a product specifying model is prepared may also include a case where a product category indicating a scope different from categories for which a product specifying model is prepared is specified. Cases where the product category specified by the VLM does not correspond to a category for which a product specifying model is prepared are not limited to these.

In this case, the category specifying unit 102 further inputs, to the VLM, an instruction to specify a product category based on a category list corresponding to the product category specified by the VLM. That is, the category specifying unit 102 inputs, to the VLM, different category lists in accordance with the product category specified by the VLM. In this case, the category specifying unit 102 inputs, to the VLM, an instruction to specify a product category of a product captured in an image, from among product categories included in the input category list. The category specifying unit 102 is capable of acquiring, as a specified result, a product category specified by the VLM from the input category list.

A case where a product specifying model is prepared for product categories included in the category list illustrated in FIG. 2 will be described as an example. For example, it is assumed that the product category specified by the VLM is “sweets”. In this case, the category list illustrated in FIG. 2 includes “cakes and Western confectionery”, “Japanese confectionery”, and “snack confectionery”. Therefore, it is difficult to select a product specifying model based on the product category “sweets”. The category specifying unit 102 inputs, to the VLM, for example, a category list including “cakes and Western confectionery”, “Japanese confectionery”, and “snack confectionery”. The category specifying unit 102 inputs an instruction to specify a product category from the input category list. The category specifying unit 102 is capable of acquiring, as a specified result, a product category specified from the input category list.

A case in which a product category specified by the VLM is “spaghetti” will be described as another example. In this case, the category list illustrated in FIG. 2 does not include a product category “spaghetti”. Among the product categories included in the category list illustrated in FIG. 2, for example, “frozen food” and “retort food” may include spaghetti. Accordingly, the category specifying unit 102 inputs, to the VLM, for example, a category list including “frozen food” and “retort food”. The category specifying unit 102 inputs an instruction to specify a product category from the input category list. The category specifying unit 102 is capable of acquiring, as a specified result, a product category specified from the input category list.

The category list input by the category specifying unit 102 is not limited to the above examples. The category specifying unit 102 is capable of selecting product categories included in the category list in accordance with the product category specified by the VLM. The category specifying unit 102 is capable of including, in a category list to be input to the VLM, product categories that are related to the product category specified by the VLM among product categories included in the category list. The category specifying unit 102 compares the product category specified by the VLM with the category list. The category specifying unit 102 is capable of selecting product categories included in the category list. Selection of product categories related to the product category specified by the VLM may be performed by a known technique.

Methods for acquiring a specified result of the product category by inputting a plurality of instructions to the VLM are not limited to these. As necessary, the category specifying unit 102 is capable of specifying a product category by inputting an instruction and a category list to the VLM.

The category specifying unit 102 may further input, to the VLM, an instruction to specify a product category based on text information. The acquisition unit 101 may extract text information included in the image. In this case, the category specifying unit 102 may input the text information to the VLM. The category specifying unit 102 is capable of inputting, to the VLM, an instruction to specify a product category further by using the text information. For example, it is assumed that the acquisition unit 101 extracts text information “oolong tea” as the text information written on the product. In this case, the category specifying unit 102 is capable of further inputting the text information “oolong tea” to the VLM. By inputting the text information to the VLM, the specifying accuracy of a product category by the VLM may be improved.

The product specifying unit 103 is an aspect of product specifying means for specifying a product by using a product specifying model corresponding to the specified product category. A product specifying model is prepared in advance for each product category. Accordingly, in specifying a product, it may be desirable to use a product specifying model corresponding to a product captured in an image. Therefore, the product specifying unit 103 is capable of using a product specifying model corresponding to a product category specified by the VLM.

The product specifying unit 103 selects a product specifying model based on the product category specified by the category specifying unit 102. The category specifying unit 102 specifies a product category of a product captured in an image, from among product categories included in a category list. The product categories included in the category list are product categories for which a product specifying model is prepared. Therefore, the product specifying unit 103 is capable of selecting a product specifying model corresponding to the product category specified by the category specifying unit 102. The product specifying unit 103 specifies a product by using the selected product specifying model. That is, the product specifying unit 103 is capable of specifying a product by using a product specifying model of the product category specified by the category specifying unit 102. Here, specifying a product means, as described above, uniquely specifying a product.

As described above, the product specifying model is a model trained using images of products for the products handled in a store. In addition, the product specifying model is a model trained to output product information including product identification information by using an image in which a product is captured, as an input. The product specifying unit 103 inputs an image in which a product is captured, to the product specifying model. The product specifying unit 103 transmits the image to the product specifying model server device 92. The product specifying model server device 92 accepts the image in which the product is captured. The product specifying model server device 92 outputs, as a specified result by the product specifying model, product information of the specified product. The product specifying unit 103 is capable of acquiring, as a specified result of the product, the product information of the specified product from the product specifying model server device 92. The product specifying unit 103 is capable of specifying the product by acquiring the product information of the specified product.

The product information acquired by the product specifying unit 103 includes product identification information. The product identification information is information capable of uniquely specifying a product. The product identification information is, for example, a product number. The product identification information may also be a product name. The product identification information is not limited thereto. The product identification information may also be a combination of a sales company and a product name. The product information may include information related to the product in addition to the product identification information. The information related to the product is, for example, a price of the product, a sales start period, and a sales company. The information related to the product may be information included in the product identification information. The product specifying unit 103 may acquire, for example, information related to the product from the database 104 based on the product identification information. The database 104 may store information of products handled in a store. The product specifying unit 103 may read product information of the product from the database 104 based on the product identification information.

The product specifying unit 103 may also input, to the product specifying model, an instruction to specify a product based on text information. In a case where the acquisition unit 101 extracts text information, the product specifying unit 103 is capable of inputting, to the product specifying model, an image in which a product is captured and an instruction to specify the product based on the text information. As described above, an example of the text information is information of text written on packaging of a product. Therefore, the accuracy of specifying a product may be improved by inputting the text information to the product specifying model. For example, in a case where the product specifying model is trained using multimodal learning, the product specifying model is capable of specifying a product based on the image and the text information.

The output unit 105 is an aspect of output means for outputting product information of the specified product in association with the image. The product specifying unit 103 specifies a product by acquiring product information of the product specified by the product specifying model. The output unit 105 is capable of outputting the product information acquired by the product specifying unit 103 in association with the image in which the product is captured. The product information includes product identification information. That is, the output unit 105 is capable of outputting an image in which the product is captured, in association with product identification information of the product.

The output unit 105 is capable of outputting, for example, the product information and the image in association with each other to the database 104. That is, the output unit 105 is capable of storing the product information and the image in association with each other in the database 104. In the database 104, an image in which a product is captured and product information of the product are stored in association with each other.

The output unit 105 may also display the product information in association with the image on a screen. The output unit 105 may output the product information and the image in association with each other to, for example, a store terminal (not illustrated) used in a store. The store terminal is a terminal used by a clerk of a store. The store terminal may be a terminal installed in a store or a terminal portable by a clerk. The store terminal is not limited to these. The product specifying device 10 and the store terminal are connected via a wired or wireless network. The output unit 105 transmits the product information and the image in association with each other to the store terminal. The store terminal acquires the product information and the image. Then, the store terminal is capable of displaying the product information and the image on a screen of the store terminal. The clerk is capable of checking the product information of the product captured in the image via the store terminal. The output destinations by the output unit 105 are not limited to these.

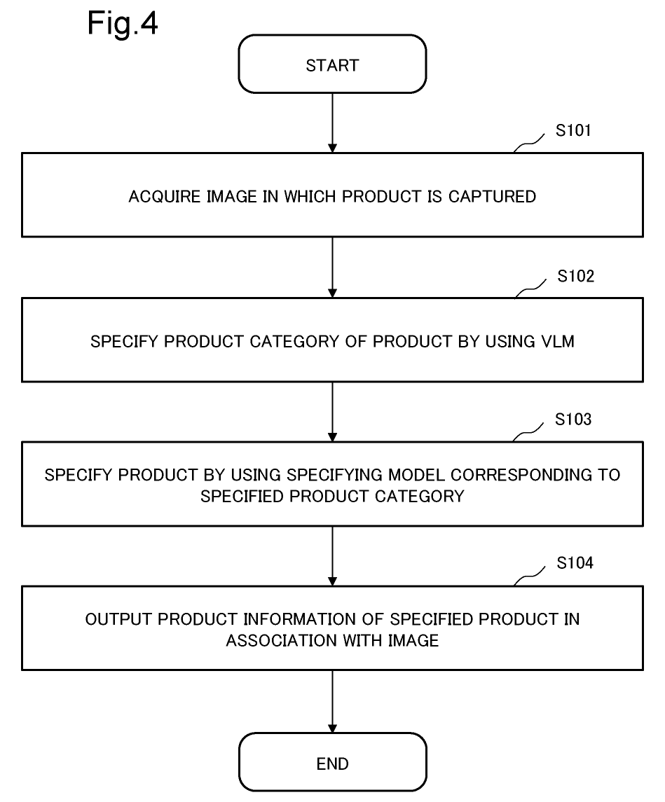

With reference to FIG. 4, an operation of the product specifying device 10 including the acquisition unit 101, the category specifying unit 102, the product specifying unit 103, the database 104, and the output unit 105 will be described. FIG. 4 is a first flowchart illustrating an example of an operation of the product specifying device.

In step S101, the acquisition unit 101 acquires an image in which a product is captured. In step S102, the category specifying unit 102 specifies a product category of the product by using the VLM. The category specifying unit 102 inputs, to the VLM, an instruction to specify a product category based on an image and a category list as a list of product categories supported by the product specifying model. In step S103, the product specifying unit 103 specifies the product by using a product specifying model corresponding to the specified product category. In step S104, the output unit 105 outputs product information of the specified product in association with the image. For example, the output unit 105 is capable of outputting, for example, the product information and the image in association with each other to the database 104. The product specifying device 10 ends the operation.

In the product specifying device 10 according to the present example embodiment, the category specifying unit 102 specifies a product category of a product by using a VLM, and the product specifying unit 103 specifies the product by using a product specifying model corresponding to the specified product category. The product specifying unit 103 specifies the product by using the product specifying model corresponding to the product category specified by the category specifying unit 102. In such cases, a product category for which a product specifying model is not prepared may be specified by the VLM. The accuracy of specifying a product may decrease in a case where a product category for which a product specifying model is not prepared is specified. However, the category specifying unit 102 inputs, to the VLM, an instruction to specify a product category based on an image and a category list that is a list of product categories supported by a product specifying model, and thereby a possibility that a product category for which a product specifying model is prepared is specified becomes higher. In a case where a product category for which a product specifying model is prepared is specified, it becomes possible to improve the specifying accuracy of the product based on an image by the product specifying unit 103.

In the product specifying device 10 according to the present example embodiment, the category specifying unit 102 inputs, to the VLM, an instruction to specify a product category based on an image, and further inputs an instruction to specify a product category based on a category list corresponding to the product category specified by the VLM. The product category specified by the VLM may be, for example, a product category that is not included in categories for which a product specifying model is prepared. The product category specified by the VLM may be a product category indicating a scope different from categories for which a product specifying model is prepared. The category specifying unit 102 further inputs, to the VLM, an instruction to specify a product category based on a category list corresponding to the product category specified by the VLM. That is, the category specifying unit 102 inputs different category lists to the VLM in accordance with the product category specified by the VLM. The VLM is capable of specifying a product category of a product captured in an image from among product categories included in the category list. That is, a possibility that a product category for which a product specifying model is prepared is specified becomes higher. In a case where a product category for which a product specifying model is prepared is specified, it becomes possible to improve the specifying accuracy of the product based on an image by the product specifying unit 103.

In the product specifying device 10 according to the present example embodiment, the category specifying unit 102 inputs, to the VLM, an instruction to specify a major category based on a major-category list of major categories and an image, and further inputs an instruction to specify a product category based on a minor-category list of minor categories corresponding to the major category specified by the VLM. Here, the product category includes a major category and a minor category obtained by subdividing the major category. The category specifying unit 102 causes the VLM to specify the major category first. Then, the category specifying unit 102 causes the VLM to specify a minor category from a minor-category list corresponding to the specified major category. Since a product specifying model is prepared for each minor category, with the above configuration, a possibility that a product category for which a product specifying model is prepared is specified becomes higher. In a case where a product category for which a product specifying model is prepared is specified, it becomes possible to improve the specifying accuracy of the product based on an image by the product specifying unit 103. The category specifying unit 102 inputs the major-category list and the minor-category list separately. For example, compared with a case where a category list including all product categories for which product specifying models are prepared is input, it becomes possible to reduce an amount of data input at one time.

In the product specifying device 10 according to the present example embodiment, the output unit 105 outputs the product information of the specified product in association with the image. The output unit 105 is capable of outputting, for example, the product information and the image in association with each other to the database 104. That is, the output unit 105 is capable of storing, in the database 104, an image in which a product is captured in association with a specified result of the product. In addition, the output unit 105 may also display the product information in association with the image on a screen. The output unit 105 may output the product information and the image in association with each other to, for example, a store terminal used in a store. In this case, for example, a clerk of a store is capable of checking whether a specified result of a product captured in the image is correct.

In the product specifying device 10 according to the present example embodiment, the category specifying unit 102 further inputs, to the VLM, an instruction to specify a product category based on text information. Here, the text information is information of text written on a product. The text information is, for example, information of text written on packaging of a product. By inputting the text information to the VLM as well, the category specifying unit 102 can improve the specifying accuracy of the category by the VLM. The product specifying unit 103 may input, to the product specifying model, an instruction to specify a product based on text information. By inputting the text information to the product specifying model, the product specifying unit 103 can improve the specifying accuracy of the product by the product specifying model.

In some cases, a product category is specified by using VLM, and a product is specified by using a product specifying model corresponding to the specified product category. In such cases, a product category for which a product specifying model is not prepared may be specified by the VLM. In a case where a product category for which a product specifying model is not prepared is specified by the VLM, there is a possibility that a product specifying accuracy decreases.

An example of an effect of the present disclosure is that it becomes possible to improve the specifying accuracy of a product based on an image.

### Second Example Embodiment

The present example embodiment will be described in detail with reference to the drawings. In the following description, description of content overlapping with the above-described description will be omitted to the extent that the description of the present example embodiment does not become unclear.

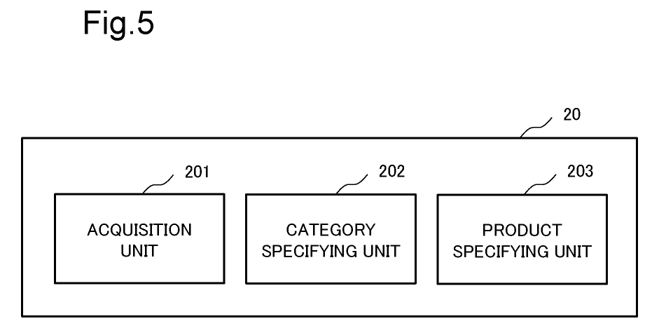

With reference to FIG. 5, a configuration of a product specifying device 20 will be described. FIG. 5 is a second block diagram illustrating an example of a configuration of the product specifying device. The product specifying device 20 includes an acquisition unit 201, a category specifying unit 202, and a product specifying unit 203.

The acquisition unit 201 is an aspect of acquisition means for acquiring an image in which a product is captured. The acquisition unit 201 acquires, from the imaging device 90, the image captured by the imaging device 90. The imaging device 90 captures an image of a product. Therefore, the acquisition unit 201 is capable of acquiring an image in which a product in a store is captured. The acquisition unit 201 may extract text information included in the image. The image captured by the imaging device 90 may include text. The acquisition unit 201 may acquire the text information as, for example, an extraction result of text included in the image. The text information is extracted from an image. A known technique is used to extract the text information.

The category specifying unit 202 is an aspect of category specifying means for specifying a product category of a product by using a VLM. The category specifying unit 202 inputs, to the VLM, an instruction to specify a product category based on an image and a category list as a list of product categories supported by the product specifying model. The category specifying unit 202 acquires a specified result of the category as an output from the VLM. The category specifying unit 202 is capable of specifying the product category by acquiring the specified result of the category.

The category specifying unit 202 can input, to the VLM, for example, the image in which a product is captured, the category list illustrated in FIG. 2, and the instruction to specify a product category. In this case, the category list to be input may be in a text format or may be an image. The VLM is capable of specifying a product category of a product captured in the image, from among the product categories included in the category list. The category specifying unit 202 acquires a specified result of the product category obtained by the VLM. The specified result of the category may be in a text format or may be an image. It is sufficient that the specified result of the category includes a product category of the product captured in the image.

The category specifying unit 202 may acquire the specified result of the product category by inputting a plurality of instructions to the VLM. A case where the product category includes a major category and a minor category will be described. The category specifying unit 202 inputs, to the VLM, an instruction to specify a major category based on a major-category list of major categories and an image. The category specifying unit 202 further inputs, to the VLM, an instruction to specify a product category based on a minor-category list of minor categories corresponding to the major category specified by the VLM. The category specifying unit 202 is capable of acquiring a specified result of the product category obtained by the VLM.

Another method of acquiring a specified result of a product category by inputting a plurality of instructions to the VLM will be described. The category specifying unit 202 inputs, to the VLM, an instruction to specify a product category based on an image. Then, the category specifying unit 202 further inputs, to the VLM, an instruction to specify a product category based on a category list corresponding to the product category specified by the VLM. The category specifying unit 202 is capable of acquiring a specified result of the product category obtained by the VLM.

The category specifying unit 202 may further input, to the VLM, an instruction to specify a product category based on text information. The acquisition unit 201 may extract text information included in the image. In this case, the category specifying unit 202 may input the text information to the VLM. The category specifying unit 202 is capable of inputting, to the VLM, an instruction to specify a product category further by using the text information.

The product specifying unit 203 is an aspect of product specifying means for specifying a product by using a product specifying model corresponding to the specified product category. A product specifying model is prepared in advance for each product category. Accordingly, in specifying a product, it may be desirable to use a product specifying model corresponding to a product captured in an image. Therefore, the product specifying unit 203 is capable of using a product specifying model corresponding to a product category specified by the VLM.

The product specifying unit 203 selects a product specifying model based on the product category specified by the category specifying unit 202. The category specifying unit 202 specifies a product category of a product captured in an image, from among product categories included in a category list. The product categories included in the category list are product categories for which a product specifying model is prepared. Therefore, the product specifying unit 203 is capable of selecting a product specifying model corresponding to the product category specified by the category specifying unit 202. The product specifying unit 203 specifies a product by using the selected product specifying model. That is, the product specifying unit 203 is capable of specifying a product by using a product specifying model of the product category specified by the category specifying unit 202. Here, specifying a product means, as described above, uniquely specifying a product.

The product specifying unit 203 may also input, to the product specifying model, an instruction to specify a product based on text information. In a case where the acquisition unit 201 extracts text information, the product specifying unit 203 is capable of inputting, to the product specifying model, an image in which a product is captured and an instruction to specify the product based on the text information. As described above, an example of the text information is information of text written on packaging of a product. Therefore, the accuracy of specifying a product may be improved by inputting the text information to the product specifying model. For example, in a case where the product specifying model is trained using multimodal learning, the product specifying model is capable of specifying a product based on the image and the text information.

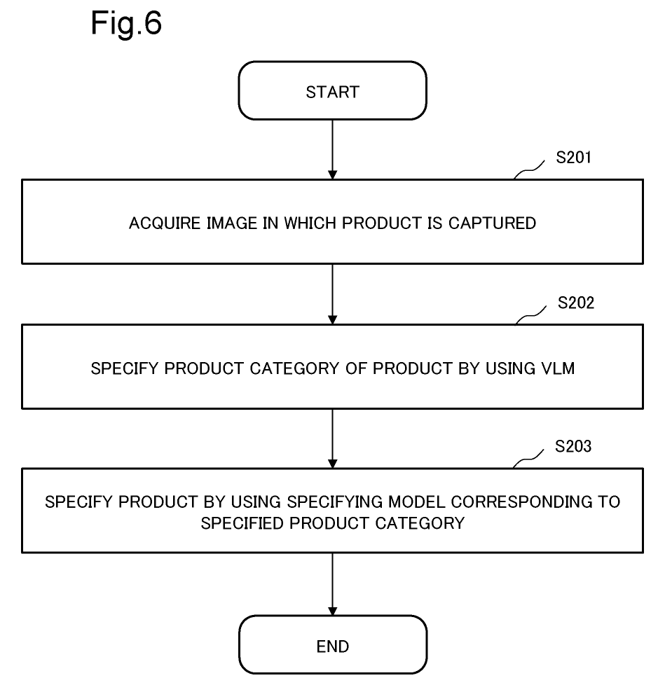

With reference to FIG. 6, an operation of the product specifying device 20 including the acquisition unit 201, the category specifying unit 202, and the product specifying unit 203 will be described. FIG. 6 is a second flowchart illustrating an example of an operation of the product specifying device. In step S201, the acquisition unit 201 acquires an image in which a product is captured. In step S202, the category specifying unit 202 specifies a product category of the product by using the VLM. The category specifying unit 202 inputs, to the VLM, an instruction to specify a product category based on an image and a category list as a list of product categories supported by the product specifying model. In step S203, the product specifying unit 203 specifies the product by using a product specifying model corresponding to the specified product category. The product specifying device 20 ends the operation.

In the product specifying device 20 according to the present example embodiment, the category specifying unit 202 specifies a product category of a product by using a VLM, and the product specifying unit 203 specifies the product by using a product specifying model corresponding to the specified product category. The product specifying unit 203 specifies the product by using the product specifying model corresponding to the product category specified by the category specifying unit 202. In such cases, a product category for which a product specifying model is not prepared may be specified by the VLM. The accuracy of specifying a product may decrease in a case where a product category for which a product specifying model is not prepared is specified. However, the category specifying unit 202 inputs, to the VLM, an instruction to specify a product category based on an image and a category list that is a list of product categories supported by a product specifying model, and thereby a possibility that a product category for which a product specifying model is prepared is specified becomes higher. In a case where a product category for which a product specifying model is prepared is specified, it becomes possible to improve the specifying accuracy of the product based on an image by the product specifying unit 203.

### Hardware Configuration Example

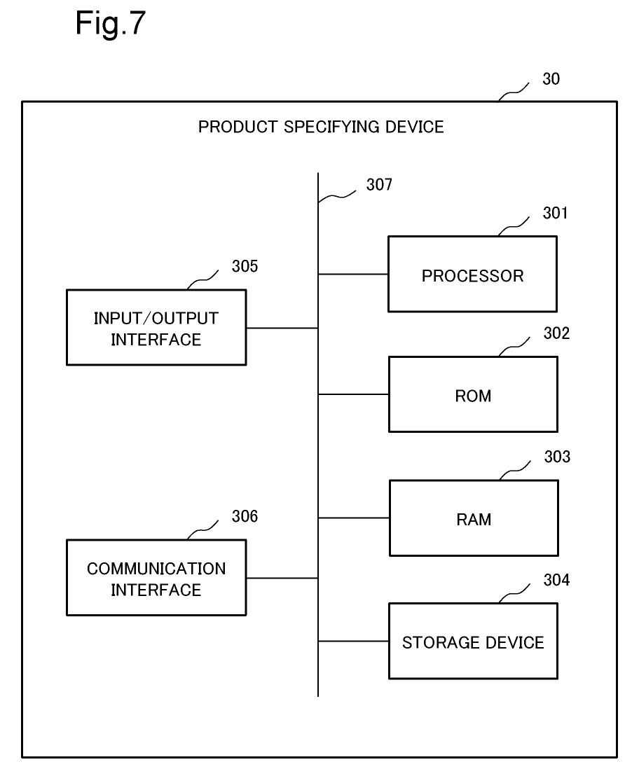

FIG. 7 is a diagram illustrating an example of a hardware configuration of a product specifying device. A product specifying device 30 is achieved by a computer. The product specifying device 30 is an example in which the product specifying device 10 or the product specifying device 20 is achieved by a computer.

The product specifying device 30 includes a processor 301, a Read Only Memory (ROM) 302, a Random Access Memory (RAM) 303, a storage device 304 such as a hard disk that stores programs, an input/output interface 305 that performs input and output of data, and a communication interface 306 for network connection. The respective components are connected via a bus 307.

The processor 301 operates an operating system to control the entirety of the computer. The processor 301 includes, for example, a Central Processing Unit (CPU), a Digital Signal Processor (DSP), and a Graphics Processing Unit (GPU). The processor 301 loads programs stored in, for example, the ROM 302 or the storage device 304. The processor 301 executes respective types of processing coded in the programs. The processor 301 may execute processing or an instruction in the flowcharts illustrated based on the programs.

The ROM 302 stores application programs and programs according to the respective example embodiments. The RAM 303 is used as a work area of the processor 301.

The storage device 304 includes, for example, a semiconductor memory such as a flash memory and a Hard Disk Drive (HDD). The storage device 304 stores, for example, an Operating System (OS) program, application programs, and programs according to the respective example embodiments.

The input/output interface 305 is connected to peripheral devices (not illustrated). The connection method may be a wired network or a wireless network.

The communication interface 306 is connected, via a wireless or wired network, to a communication network (not illustrated) such as a Local Area Network (LAN) or a Wide Area Network (WAN). The communication network may be configured by a plurality of communication networks. Accordingly, the computer is connected to an external device via the communication network. The product specifying device 30 may include components other than those illustrated in FIG. 7. For example, the product specifying device 30 may include a drive device. For example, the processor 301 may be mounted in a drive device and may read programs or data stored in a non-transitory tangible recording medium into the RAM 303.

The present disclosure has been described above with reference to the example embodiments, but the present disclosure is not limited to the above-described example embodiments. Various modifications to the configuration and details of the present disclosure can be made within the scope of the present disclosure as can be understood by those skilled in the art. The configurations in the respective example embodiments can be combined with each other as long as such combinations do not depart from the scope of the present disclosure.

Some or all of the above-described example embodiments may also be described as the following supplementary notes, but are not limited thereto.
Supplementary Note 1
   A product specifying device includes
   acquisition means for acquiring an image in which a product is captured;
   category specifying means for specifying a product category of the product by using a VLM; and
   product specifying means for specifying the product by using a product specifying model corresponding to the specified product category, in which
   the category specifying means inputs, to a VLM, an instruction to specify the product category based on the image and a category list that is a list of product categories supported by the product specifying model.
Supplementary Note 2
   The product specifying device according to Supplementary Note 1, in which
   the category specifying means inputs an instruction to specify the product category based on the image, to the VLM, and further inputs an instruction to specify the product category based on a category list corresponding to the product category specified by the VLM.
Supplementary Note 3
   The product specifying device according to Supplementary Note 1, in which the
   product category includes major categories and minor categories obtained by subdividing the major categories, and
   the category specifying means inputs, to the VLM, an instruction to specify the major category based on a major-category list of the major categories and the image, and further inputs an instruction to specify the product category based on a minor-category list of the minor categories corresponding to the major category specified by the VLM.
Supplementary Note 4
   The product specifying device according to any one of Supplementary Notes 1 to 3, further including:
   output means for outputting product information of the specified product in association with the image.
Supplementary Note 5
   The product specifying device according to Supplementary Note 1, in which
   the acquisition means further extracts text information included in the image, and
   the category specifying means inputs, to the VLM, an instruction to specify the product category further based on the text information.
Supplementary Note 6
   The product specifying device according to Supplementary Note 5, in which
   the product specifying means inputs, to the product specifying model, an instruction to specify the product based on the text information.
Supplementary Note 7
   The product specifying device according to Supplementary Note 5 or 6, in which
   the text information is information of text written on the product.
Supplementary Note 8
   The product specifying device according to any one of Supplementary Notes 1 to 3, in which
   the product specifying means inputs the image to the product specifying model, and acquires a specified result of the product.
Supplementary Note 9
   A product specifying method including:
   acquiring an image in which a product is captured;
   by inputting an instruction to specify a product category of the product captured in the image to a VLM, specifying the product category of the product captured in the image based on the image and a category list that is a list of product categories supported by a product specifying model; and
   specifying the product by using a product specifying model corresponding to the specified product category.
Supplementary Note 10
   A program causing a computer to execute processing of
   acquiring an image in which a product is captured;
   by inputting an instruction to specify a product category of the product captured in the image to a VLM, specifying the product category of the product captured in the image based on the image and a category list that is a list of product categories for which a product specifying model is prepared; and
   specifying the product by using a product specifying model corresponding to the specified product category.
Supplementary Note 11
A recording medium that stores a program causing a computer to execute processing of
acquiring an image in which a product is captured;
by inputting an instruction to specify a product category of the product captured in the image to a VLM, specifying the product category of the product captured in the image based on the image and a category list that is a list of product categories for which a product specifying model is prepared; and
specifying the product by using a product specifying model corresponding to the specified product category.

Some or all of the configurations described in Supplementary Notes 2 to 8 dependent on the above-described Supplementary Note 1 can also be dependent on Supplementary Notes 9 to 11 by the dependency relationship similar to that of Supplementary Notes 2 to 8. Furthermore, some or all of the configurations described as the Supplementary Notes can be similarly dependent on not only the Supplementary Notes 1, and 9 to 11, but also various pieces of hardware and software, and various recording devices or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A product specifying device comprising:
one or more memories storing instructions; and
one or more processors configured to execute the instructions to:
acquire an image in which a product is captured;
by inputting an instruction to specify a product category of the product captured in the image to a Vision Language Model (VLM), specify the product category of the product captured in the image based on the image and a category list that is a list of product categories for which a product specifying model is prepared; and
specify the product by using a product specifying model corresponding to the specified product category.

2. The product specifying device according to claim 1, wherein
the one or more processors are further configured to execute the instructions to:
input, to the VLM, an instruction to specify the product category based on the image; and
input, to the VLM, an instruction to specify the product category based on a category list corresponding to the product category specified by the VLM.

3. The product specifying device according to claim 1, wherein
the product category includes major categories and minor categories obtained by subdividing the major categories, and
the one or more processors are further configured to execute the instructions to input, to the VLM, an instruction to specify the major category based on a major-category list of the major categories and the image, and to input, to the VLM, an instruction to specify the product category based on a minor-category list of the minor categories corresponding to the major category specified by the VLM.

4. The product specifying device according to claim 1, wherein
the one or more processors are further configured to execute the instructions to output product information of the specified product in association with the image.

5. The product specifying device according to claim 1, wherein
the one or more processors are further configured to execute the instructions to:
extract text information included in the image, and
input, to the VLM, an instruction to specify the product category further based on the text information.

6. The product specifying device according to claim 5, wherein
the one or more processors are further configured to execute the instructions to input, to the product specifying model, an instruction to specify the product based on the text information.

7. The product specifying device according to claim 5, wherein
the text information is information of text written on the product.

8. The product specifying device according to claim 1, wherein
the one or more processors are configured to execute the instructions to input the image to the product specifying model, and acquire a result of specifying the product.

9. A product specifying method comprising:
by a computer,
acquiring an image in which a product is captured;
by inputting an instruction to specify a product category of the product captured in the image to a VLM, specifying the product category of the product captured in the image based on the image and a category list that is a list of product categories for which a product specifying model is prepared; and
specifying the product by using a product specifying model corresponding to the specified product category.

10. A non-transitory recording medium that stores a program causing a computer to execute:
acquiring an image in which a product is captured;
by inputting an instruction to specify a product category of the product captured in the image to a VLM, specifying the product category of the product captured in the image based on the image and a category list that is a list of product categories for which a product specifying model is prepared; and
specifying the product by using a product specifying model corresponding to the specified product category.
